(19) United States
(12) Patent Application Publication
(10) Pub. No.: US 2014/0372168 A1
(43) Pub. Date: Dec. 18, 2014

(54) SYSTEMS AND METHODS OF INITIATING CONTACT WITH A PROSPECT

(71) Applicant: salesforce.com, inc., San Francisco, CA (US)

(72) Inventor: Blake Markham, San Francisco, CA (US)

(73) Assignee: salesforce.com, inc., San Francisco, CA (US)

(21) Appl. No.: 14/190,030

(22) Filed: Feb. 25, 2014

Related U.S. Application Data
(60) Provisional application No. 61/835,192, filed on Jun. 14, 2013.

(51) Int. Cl. G06Q 30/00

(52) U.S. Cl. CPC G06Q 30/01
USPC 705/7.29

(57) ABSTRACT

The technology disclosed relates to easily and efficiently initiating contact with a prospect. In particular, it relates to identifying colleagues of a sales representative that are connected to the prospect and further determining strength of relationships between the colleagues and the prospect. The strength of relationships is determined by logging levels of communication between the colleagues and the prospect on one or more communication media and calculating proximity metrics dependent on commentary provided by the colleagues about the prospect.

### RELATED APPLICATION

The application claims the benefit of U.S. provisional Patent Application No. 61/835,192, entitled, “Systems and Methods for Determining Relationship Proximity Between Users of On-Demand Systems,” filed on Jun. 14, 2013 (Attorney Docket No. SALE 1055-1/1206PROV). The provisional application is hereby incorporated by reference for all purposes.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

As the volume of information flowing on the web continues to increase, the need for automated tools that can assist users in receiving information valuable to them also increases. The information overload created by a multitude of information sources, such as websites and social media sites, makes it difficult for users to know what piece of information is more suitable, relevant, or appropriate to their needs and desires. Also, a substantial portion of users' web surfing time is spent on separating key information from noise.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 shows an example environment of determining strength of a relationship with a prospect.

FIG. 2 illustrates one implementation of a proximity report of a business entity.

FIG. 3 shows one implementation of a proximity report of a person.

FIG. 4 is one implementation of accepting commentary about a prospect.

FIG. 5 illustrates one implementation of accepting a specification for a relationship strength metric.

FIG. 6 is one implementation of sending an introduction request for initiating contact with a prospect.

FIG. 7 shows one implementation of rewarding users for establishing connections with prospects.

FIG. 8 illustrates one implementation of a connection statistics dashboard.

FIG. 9 shows one implementation of a plurality of objects that can be used for initiating contact with a prospect.

FIG. 10 is a flowchart of one implementation of initiating contact with a prospect.

FIG. 11 is a block diagram of an example computer system for initiating contact with a prospect.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

Examples of systems, apparatus, and methods according to the disclosed implementations are described in a “sales” context. The examples of sales participants such as sales representatives and prospects are being provided solely to add context and aid in the understanding of the disclosed implementations. In other instances, the technology disclosed can be used for identifying potential customers or thought leaders. Other applications are possible, such that the following examples should not be taken as definitive or limiting either in scope, context or setting. It will thus be apparent to one skilled in the art that implementations may be practiced in or outside the “sales” context.

The technology disclosed relates to initiating contact with a prospect by using computer-implemented systems. The technology disclosed can be implemented in the context of any computer-implemented system including a database system, a multi-tenant environment, or the like. Moreover, this technology can be implemented using two or more separate and distinct computer-implemented systems that cooperate and communicate with one another. This technology can be implemented in numerous ways, including as a process, a method, an apparatus, a system, a device, a computer readable medium such as a computer readable storage medium that stores computer readable instructions or computer program code, or as a computer program product comprising a computer usable medium having a computer readable program code embodied therein.

As used herein, the “identification” of an item of information does not necessarily require the direct specification of that item of information. Information can be “identified” in a field by simply referring to the actual information through one or more layers of indirection, or by identifying one or more items of different information which are together sufficient to determine the actual item of information. In addition, the term “specify” is used herein to mean the same as “identify.”

As used herein, a given signal, event or value is “dependent on” a predecessor signal, event or value if the predecessor signal, event or value influenced the given signal, event or value. If there is an intervening processing element, step or time period, the given signal, event or value can still be “dependent on” the predecessor signal, event or value. If the intervening processing element or step combines more than one signal, event or value, the signal output of the processing element or step is considered “dependent on” to each of the signal, event or value inputs. If the given signal, event or value is the same as the predecessor signal, event or value, this is merely a degenerate case in which the given signal, event or value is still considered to be “dependent on” the predecessor signal, event or value. “Responsiveness” of a given signal, event or value upon another signal, event or value is defined similarly.

### Introduction

The technology disclosed can be applied to solve the problem of easily and efficiently reaching out to prospects. Pitching to gatekeepers, influencers, recommenders, or decision makers of sales prospects can save sales representatives valuable time and shorten sales cycles. However, this requires knowing internal information about the sales prospect to which most sales representative are not privy to. Further, merely knowing key individuals of sales prospects is not enough; as such individuals usually require a reference before entertaining new sales offers and engaging in significant sales deals.

The technology disclosed can be used to determine how to reach out to a prospect for an initial contact or strengthen existing contacts by identifying key individuals working for the organization and finding colleagues of the sales representative initiating the contact who have already established relationship with the prospect or individuals working for the prospect. The technology disclosed further enhances the result of the finding by evaluating strength of relationship between the colleagues and the prospect or individuals working for the prospect by logging the levels of communications between the colleagues and the prospect on one or more communication media and calculating a proximity metric dependent on commentary provided by the colleagues about the prospect. Once the most proximate colleagues are identified, the sales representatives can send introduction requests to those colleagues for initiating contact with the corresponding prospect.

### Relationship Strength Determination Environment

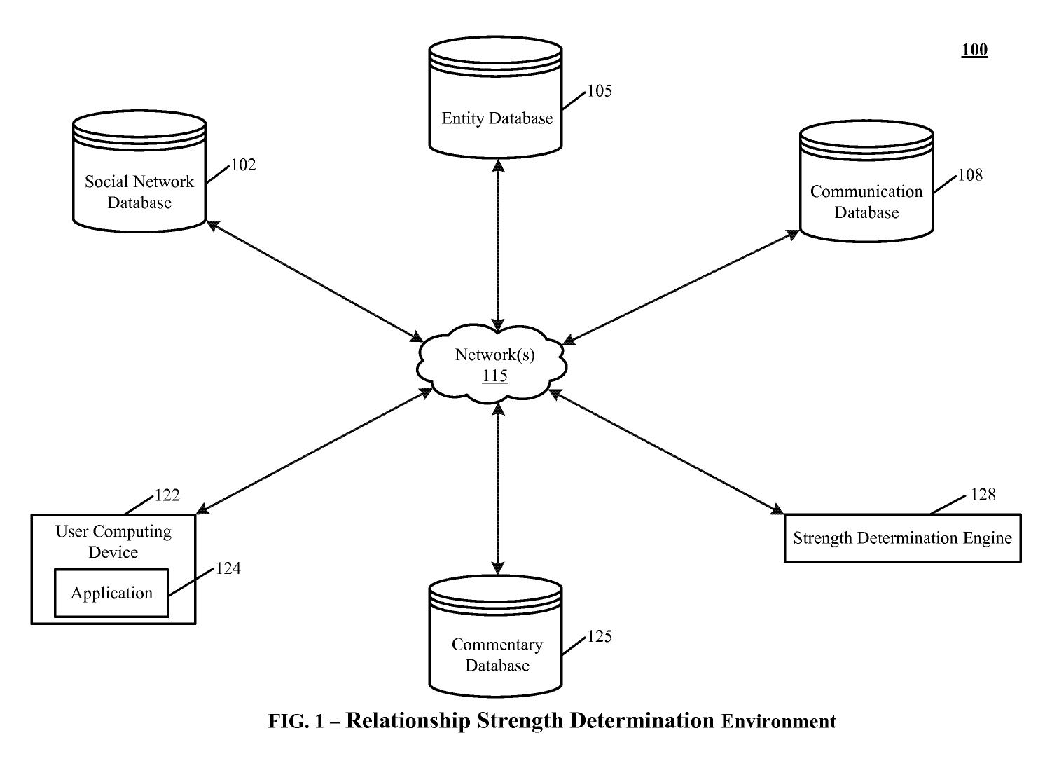

FIG. 1 shows an example environment 100 of determining strength of a relationship with a prospect. FIG. 1 includes a social network database 102, entity database 105, communication database 108, and commentary database 125. FIG. 1 also shows user computing device 122, application 124, network(s) 115, and strength determination engine 128. In other implementations, environment 100 may not have the same elements or components as those listed above and/or may have other/different elements or components instead of, or in addition to, those listed above, such as a communication logger, proximity metric, or introduction trigger. The different elements or components can be combined into single software modules and multiple software modules can run on the same hardware.

In some implementations, network(s) 115 can be any one or any combination of Local Area Network (LAN), Wide Area Network (WAN), WiFi, WiMax, telephone network, wireless network, point-to-point network, star network, token ring network, hub network, peer-to-peer connections like Bluetooth, Near Field Communication (NFC), Z-Wave, ZigBee, or other appropriate configuration of data networks, including the Internet.

In some implementations, the engine can be of varying types including a workstation, server, computing cluster, blade server, server farm, or any other data processing system or computing device. The engine can be communicably coupled to the databases via a different network connection. For example, strength determination engine 128 can be coupled via the network 115 (e.g., the Internet) or to a direct network link.

In some implementations, datastores can store information from one or more tenants into tables of a common database image to form a multi-tenant database system (MTS). A database image can include one or more database objects. In other implementations, the databases can be relational database management systems (RDBMSs), object oriented database management systems (OODBMSs), distributed file systems (DFS), no-schema database, or any other data storing systems or computing devices. In some implementations, user computing device 122 can be a personal computer, laptop computer, tablet computer, smartphone, personal digital assistant (PDA), digital image capture devices, and the like.

Application 124 can take one of a number of forms, including user interfaces, dashboard interfaces, engagement consoles, and other interfaces, such as mobile interfaces, tablet interfaces, summary interfaces, or wearable interfaces. In some implementations, it can be hosted on a web-based or cloud-based social application running on a computing device such as a personal computer, laptop computer, mobile device, and/or any other hand-held computing device. It can also be hosted on a non-social local application running in an on-premise environment. In one implementation, application 124 can be accessed from a browser running on a computing device. The browser can be Chrome, Internet Explorer, Firefox, Safari, and the like. In other implementations, application 124 can run as an engagement console on a computer desktop application.

Entity database 105 specifies various entities (persons and organizations) such as contacts, accounts, opportunities, and/or leads and further provides business information related to the respective entities. Examples of business information can include names, addresses, job titles, number of employees, industry types, territories, market segments, contact information, employer information, stock rates, SIC codes, and NAICS codes. In one implementation, entity database 105 can store web or database profiles of the users and organizations as a system of interlinked hypertext documents that can be accessed via the network 115 (e.g., the Internet). In another implementation, entity database 105 can also include standard profile information about persons and organizations. This standard profile information can be extracted from company websites, business registration sources such as Jigsaw, Hoovers, or D&B, business intelligence sources such as Yelp or Yellow Pages, and social networking websites like Chatter, Facebook, Twitter, or LinkedIn.

Social network database 102 includes a user's social network of connections on social networking websites like Chatter, Facebook, Twitter, and LinkedIn. It identifies other users that have been designated by the user as connections by forming relationships with other users or otherwise indicating an association with one or more other users. In the social network, the user contributes and interacts with media items, uses applications, joins groups, lists and confirms attendance at events, creates pages, and performs other tasks that facilitate social interaction with his connections. In one implementation, the user can have a very large number of connections, and these connections can be drawn from a variety of different experiences in the user's real life. For example, the user can have a number of connections from school, other connections from work, and still other sets of connections that form different social circles.

Communication database 108 identifies interactions between users or between sales representatives and prospects on different text, audio, and video communication media. In one implementation, electronic interactions between users on email clients like Outlook, Gmail, or Hotmail can be logged in communication database 108. In another implementation, it holds chat exchanges between users on different chat facilities such as Yahoo Messenger, GChat, or Skype. In another implementation, communication database 108 specifies check-in events logged by users with other users on check-in applications like Salesforce.com's sales logger, Foursquare, or Facebook. In yet another implementation, voice, and video calls between users can be recorded in the communication database 108.

In some implementations, interaction metadata is also logged in communication database 108. Examples of interaction metadata include character count of email bodies, number of email exchanges in email threads, character count of chat messages, chat message counts, number of voice or video calls, and duration of voice or video calls.

Commentary database 125 holds commentary and comments provided by users (sales representatives) about other users (prospects). In some implementations, commentary by a user about an entity or prospect identifies how the user knows the prospect, length of time the user has known the prospect, a specification of strength of their relationship, and a label that stratifies their relationship-type to one or more categories.

Strength determination engine 128 determines levels of communication between users or between sales representatives and prospects on one or more communication media and calculates proximity metrics dependent on the commentary provided by the users or sales representatives about other entities or prospects. In one implementation, it can apply a counter that counts the number or length of interactions on different communication media. In another implementation, it can use natural language processing algorithms like phrase detection (chunking), syntactic analysis, word sense disambiguation, or semantic analysis to determine the character counts of text messages.

In some implementations, strength determination engine 128 runs analytics such as ranking, annotation, clustering, classification, and prioritization over the generated results. In other implementations, it can stratify the prospects into industry types, geographic territories, job functions, skills, or expertise preferred by the user, professional circles of the user, degrees of separation with the user, social proximities to user, or location proximities to the user.

### Proximity Report

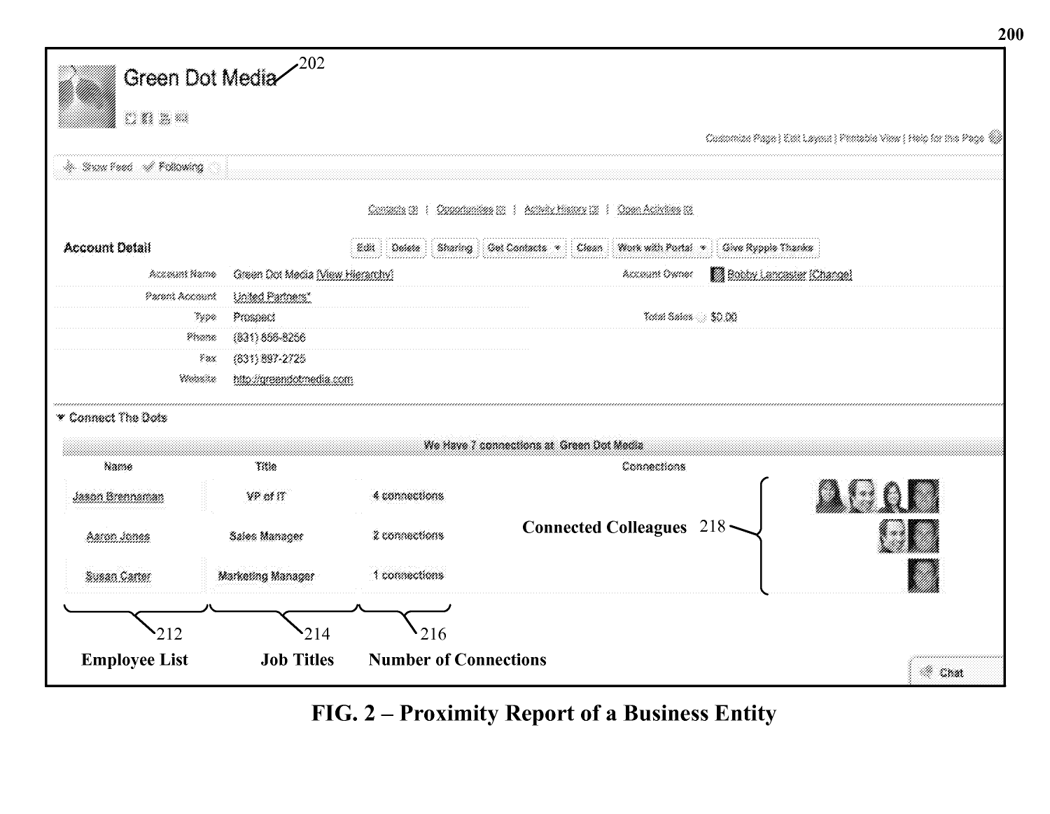

FIG. 2 illustrates one implementation of a proximity report 200 of a business entity. In particular, FIG. 2 shows a proximity report 200 generated for a business entity named “Green Dot Media” 202. Proximity report 200 presents a list of employees 212 that work for Green Dot Media 202 along with their respective job titles 214. It further identifies colleagues 218 of a sales representative that are connected to respective employees of Green Dot Media 202. In other implementations, FIG. 2 may not have the same proximity objects as those listed above and/or may have other/different proximity objects instead of, or in addition to, those listed above such as a degree of separation object, or location proximity object.

As shown in FIG. 2, when a sales representative selects Green Dot Media 202 as the prospect with whom he would like to establish an initial contact or strengthen an existing contact, a proximity report 200 is generated and presented to the sales representative. Proximity report 200 identifies ‘Jason Brennaman’, ‘Aaron Jones’, and ‘Susan Carter’ as employees 212 of Green Dot Media 202 and also specifies their respective job titles 214, being ‘vice-president of information technology (IT)’, ‘sales manager’, and ‘marketing manager’ respectively.

Additionally, proximity report 200 also identifies colleagues 218 of the sales representative and counts 216 of colleagues that are connected to Green Dot Media employees 212. FIG. 2 shows that the sales representative has four colleagues that are connected to the IT vice-president of Green Dot Media 202, two colleagues that are connected to the sales manager 202, and one colleague connected to the marketing manager 202.

In some implementations, proximity report 200 can provide additional content such as social profiles, social personas, digital business cards, images, contact information, or social handles of the employees 212 and colleagues 218, or provide links thereto. In other implementations, it can specify the one or more social networks in which the colleagues 218 are connected to employees 212.

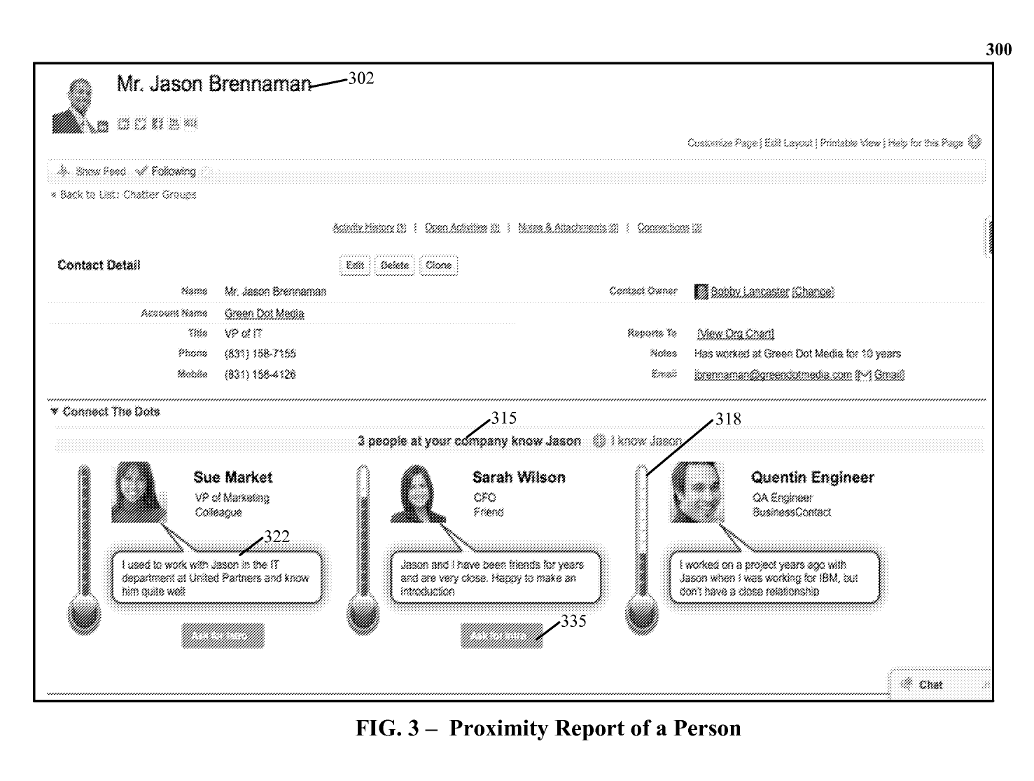

FIG. 3 shows one implementation of generating a proximity report 300 of a person named ‘Jason Brennaman’ 302, an employee of the prospect company. When a sales representative selects Jason Brennaman 302 as the prospect with whom he would like to establish or strengthen contact, a proximity report 300 is generated and presented to the sales representative. Proximity report 300 outlines colleagues 315 of the sales representative who are connected to Jason Brennaman 302. In one implementation, proximity report 300 includes commentary 322 from colleagues 315 on how they know the prospect 302, a proximity metric 318 that quantifies their relationship strength, and an introduction requester 335 to ask colleagues 315 for an introduction with the prospect 302.

### Commentary Interface

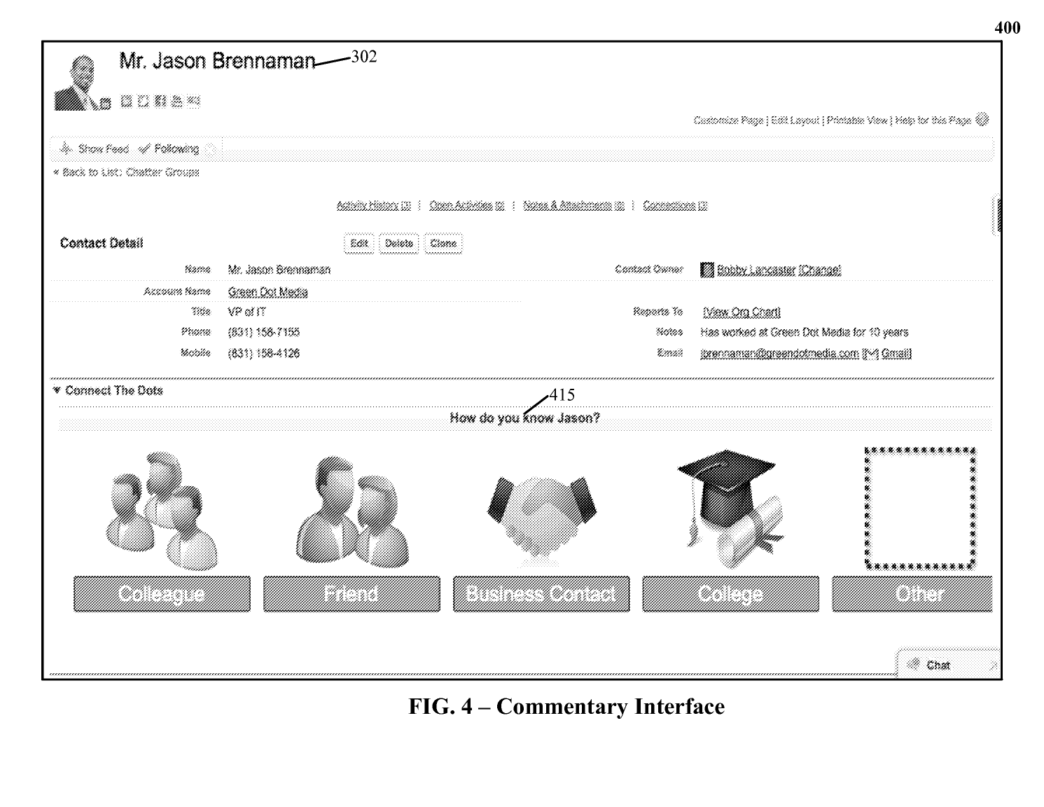

FIG. 4 is one implementation of accepting commentary about a prospect named ‘Jason Brennaman’ 302. In particular, FIG. 4 shows one implementation of an interface 400 that can be used to relate information from a sales representative or other members of sales representative's organization about their relationship with the prospect named Jason Brennaman 302. In other implementations, interface 400 may not have the same relational objects as those listed above and/or may have other/different relational objects instead of, or in addition to, those listed above such as a background object, length of relationship object, or relationship-type object.

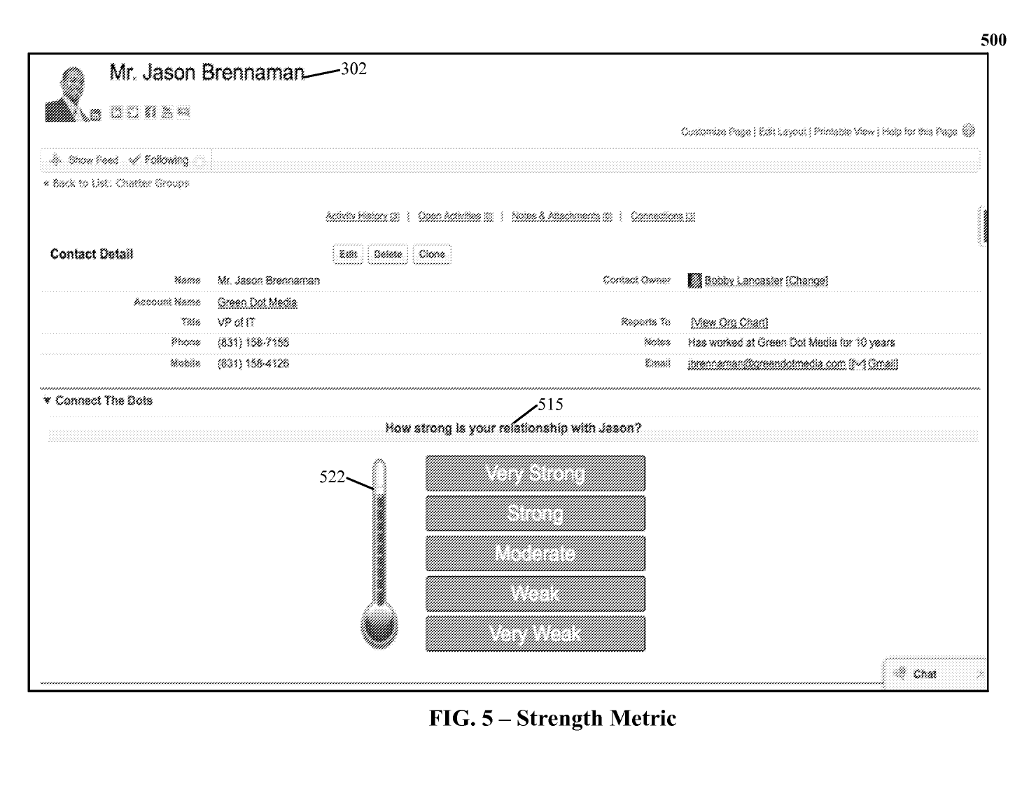

Using pane 415 shown in FIG. 4, the sales representative or other members of his organization can specify how they know Jason Brennaman 302; this is either as a work colleague, friend, business contact, school colleague, or other. Similarly, FIG. 5 illustrates one implementation of accepting a specification 500 for a relationship strength metric. The relationship strength metric includes different proximity levels such as ‘very strong’, ‘strong’, moderate, ‘weak’, and ‘very weak’. In one implementation, relationship strength metric also provides a corresponding graphic proximity metric 522 for the different proximity levels.

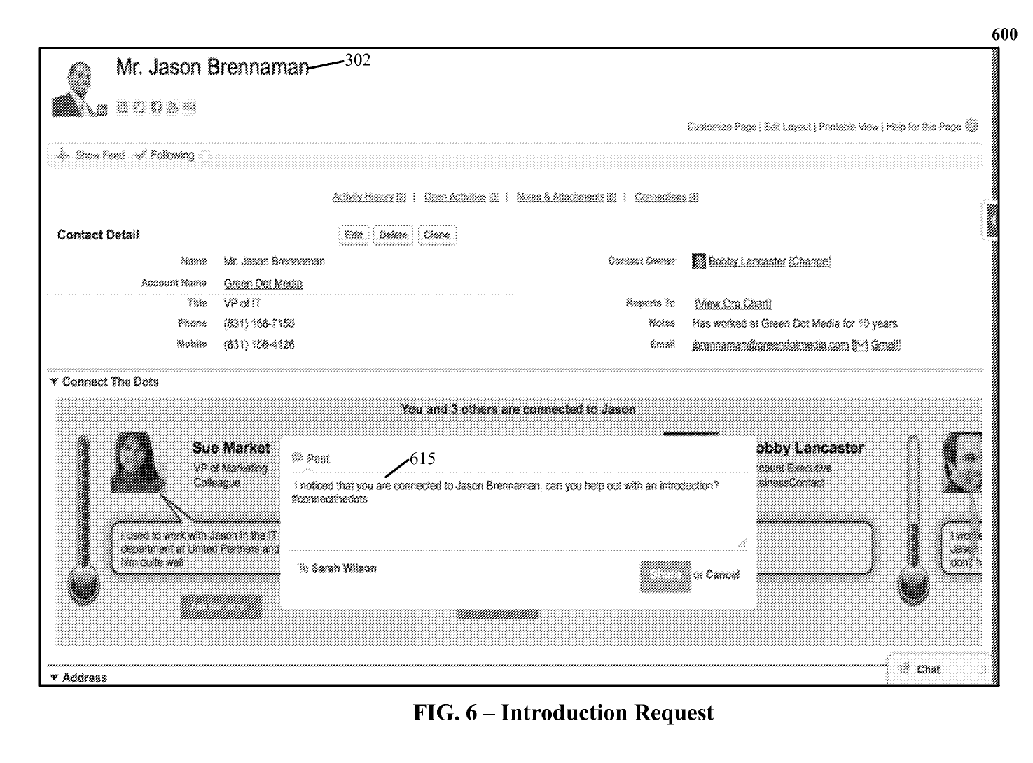

FIG. 6 is one implementation of sending an introduction request for initiating contact with a prospect. In particular, FIG. 6 shows one implementation of an interface 600 that can be used to send an introduction request 615 to a colleague who is connected to a prospect. In FIG. 6, a sales representative send an introduction request 615 to his colleague named ‘Sarah Wilson’ who is connected to a prospect named Jason Brennaman 302. In one implementation, the introduction request 615 can be in the form of an email, a post, or a text message. In another implementation, the introduction request 615 can include social profiles, social personas, digital business cards, images, contact information, or social handles of the sales representative.

The commentary provided by the identified colleagues about the respective employees also assigns one or more labels to types of their relationships with the respective employees. The method further includes presenting a ranked colleagues list that ranks the identified colleagues dependent on strength of their relationships with the respective employees of the particular entity.

### Gamification

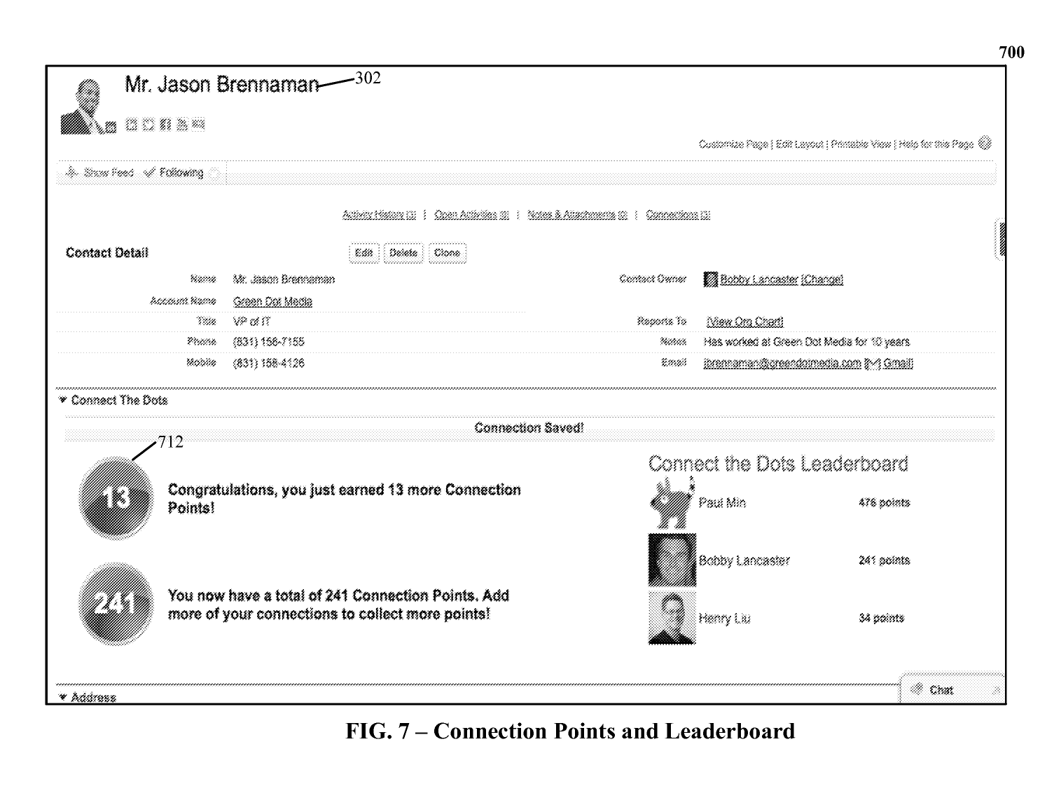

FIG. 7 shows one implementation of rewarding users for establishing connections with prospects. In one implementation, sales representatives or their colleagues can be rewarded for establishing connections with prospects. As shown in FIG. 7, users are awarded connection points 712 for every connection that they make with a prospect (Jason Brennaman 302). In another implementation, a comparative analysis can be applied to generate a ranked list or leaderboard 700 that ranks the users based on the number of connection points they have earned.

### Statistics Dashboard

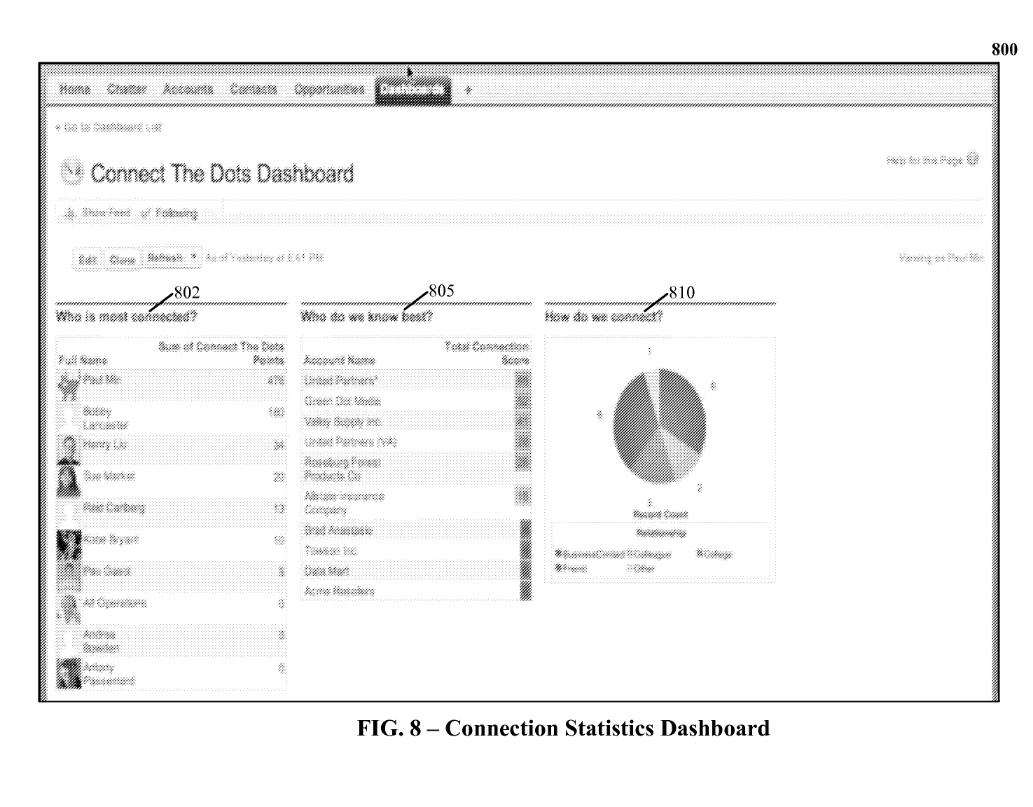

FIG. 8 illustrates one implementation of a connection statistics dashboard 800. Connection statistics dashboard 800 can generate different statistics related to prospect connections. In one implementation, it includes a ‘most-connected’ list 802 that ranks different users based on the overall total of their connection points. In another implementation, it includes a ‘best-known’ list 805 that ranks different business entities based on the overall total of connection points with regards to their employees. In another implementation, it includes a ‘connection-domain’ chart 810 that identifies the different types of relationships users have with prospects along with their quantitative distribution.

### Connection Records

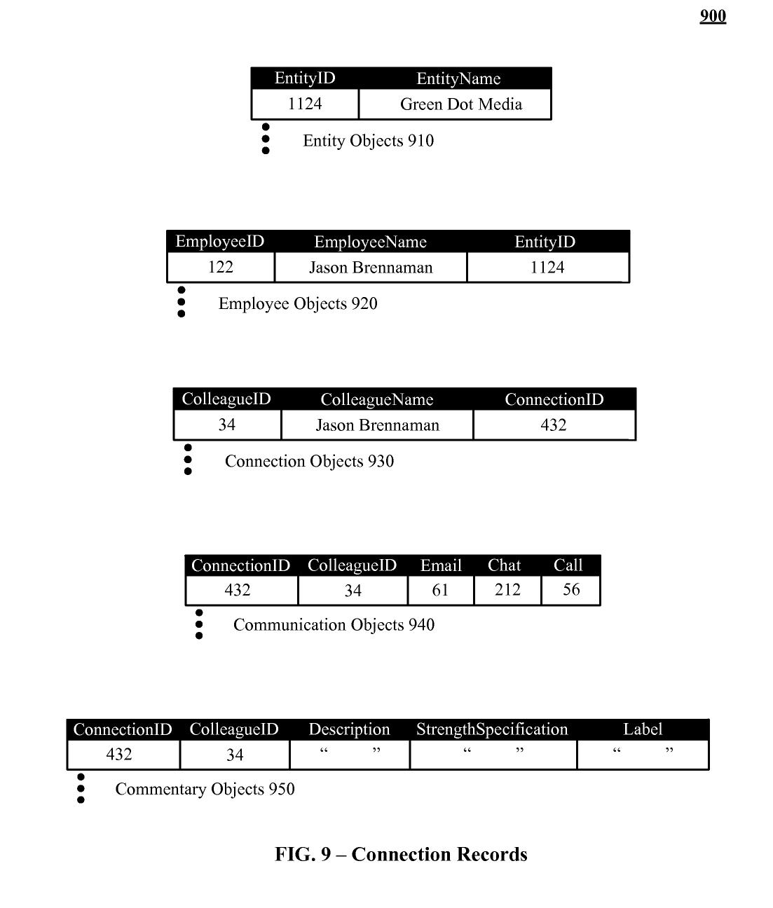

FIG. 9 shows one implementation of a plurality of objects 900 that can be used for initiating contact with a prospect. As described above, this and other data structure descriptions that are expressed in terms of objects can also be implemented as tables that store multiple records or object types. Reference to objects is for convenience of explanation and not as a limitation on the data structure implementation. FIG. 9 shows entity objects 910, employee objects 920, connection objects 930, communication objects 940, and commentary objects 950. In other implementations, objects 900 may not have the same objects, tables, entries or fields as those listed above and/or may have other/different objects, tables, entries or fields instead of, or in addition to, those listed above such as a proximity object or statistics object.

Entity objects 910 uniquely identify entities using “EntitylD” field and provide supplemental information about the entities like first names, last names, employer information, job titles, contact information, usernames, and unified resource locators (URLs) of entities' profiles on social networking websites. For instance, entity objects 910 specify a business entity named ‘Green Dot Media’ that has an EntityID of 1124. Employee objects 920 uniquely identify employees working for a business entity using “EmployeeID” field. For instance, employee objects 920 specify an employee of Green Dot Media named ‘Jason Brennaman’, who has an EmployeeID of 122.

Connections objects 930 record information about a connection between a user and a prospect. In one example, a colleague can be identified by a ‘ColleagueID’ and the prospect can be identified by a ‘ConnectionID’. Communication objects 940 record communications between a user and a prospect on different communication media such as email, chat, and calls using ‘Email’, ‘Chat’, and ‘Call’ fields respectively. In one implementation, it stores email bodies, chat messages, and call durations.

Commentary objects 950 hold commentary provided by users about prospects. In one example, an object includes the text of a comment provided in the commentary (‘Description’ field), a specification for their relationship strength using (‘StrengthSpecification’ field), and a label for the type of relationship they have (‘Label’ field).

In other implementations, persona schema 600 can have one or more of the following variables with certain attributes: ORGANIZATION_ID being CHAR (15 BYTE), USER_ID being CHAR (15 BYTE), RELATIONSHIP_ID being CHAR (15 BYTE), INTERACTION_ID being CHAR (15 BYTE), DESCRIPTION_ID being CHAR (15 BYTE), CREATED_BY being CHAR (15 BYTE), CREATED_DATE being DATE, and DELETED being CHAR (1BYTE).

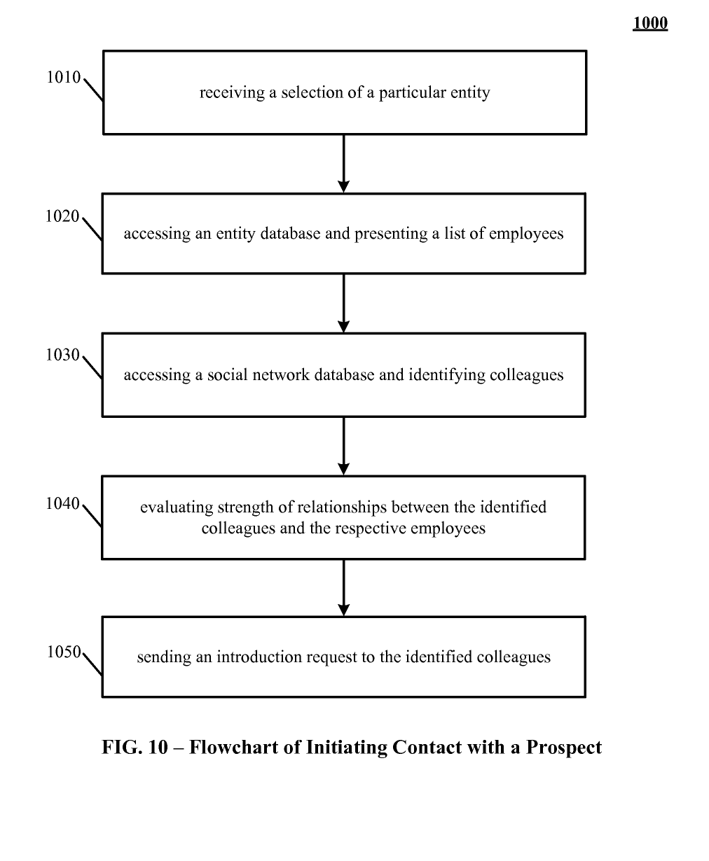

Flowchart of Initiating Contact with a Prospect FIG. 10 is a flowchart 1000 of one implementation of initiating contact with a prospect. Flowchart 1000 can be implemented at least partially with a database system, e.g., by one or more processors configured to receive or retrieve information, process the information, store results, and transmit the results. Other implementations may perform the actions in different orders and/or with different, fewer or additional actions than those illustrated in FIG. 10. Multiple actions can be combined in some implementations. For convenience, this flowchart is described with reference to the system that carries out a method. The system is not necessarily part of the method.

At action 1010, a sales representative who wants to establish an initial contact or strengthen contact with the particular entity selects the particular entity. In one implementation, the selection is received by a user commit behavior that can be executed by a voice, visual, physical, or text command. Examples of such a user commit behavior include speaking in a microphone, blinking of eye across an eye tracking device, moving a body part across a motion sensor, pressing a button on a device, selecting a screen object on an interface, or entering data across an interface.

At action 1020, an entity database 105 is accessed and a list of employees 212 of the particular entity is presented. The list identifies respective titles and job functions 214 of the employees 212. In one implementation, entity database 105 specifies various entities (persons and organizations) such as contacts, accounts, opportunities, and/or leads and further provides business information related to the respective entities 212. Examples of business information can include names, addresses, job titles, number of employees, industry types, territories, market segments, contact information, employer information, stock rates, SIC codes, and NAICS codes. In another implementation, entity database 105 can store web or database profiles of the users and organizations as a system of interlinked hypertext documents that can be accessed via the network 115 (e.g., the Internet). In yet another implementation, entity database 105 can also include standard profile information about persons and organizations. This standard profile information can be extracted from company websites, business registration sources such as Jigsaw, Hoovers, or D&B, business intelligence sources such as Yelp or Yellow Pages, and social networking websites like Chatter, Facebook, Twitter, or LinkedIn.

At action 1030, a social network database 102 is accessed and colleagues 218 of the sales representative are identified, who are connected to respective employees listed in the list of employees 212. In one implementation, social network database 102 includes a user's social network of connections on social networking websites like Chatter, Facebook, Twitter, and LinkedIn. It identifies other users that have been designated by the user as connections by forming relationships with other users or otherwise indicating an association with one or more other users. In the social network, the user contributes and interacts with media items, uses applications, joins groups, lists and confirms attendance at events, creates pages, and performs other tasks that facilitate social interaction with his connections. In one implementation, the user can have a very large number of connections, and these connections can be drawn from a variety of different experiences in the user's real life.

At action 1040, strength of relationships between the identified colleagues 218 and the respective employees 212 is evaluated. In one implementation, the evaluation includes determining levels of communication between the identified colleagues 218 and the respective employees 212 on one or more communication media. Determination of levels of communication between the identified colleagues 218 and the respective employees 212 is dependent on number of emails exchanged between the colleagues 218 and the respective employees 212 on email clients. Determination of levels of communication between the identified colleagues 218 and the respective employees 212 is also dependent on number of chat messages exchanged between the colleagues 218 and the respective employees 212 on chat facilities. Determination of levels of communication between the identified colleagues 218 and the respective employees 212 is also dependent on number of check-in events, linked to the respective employees 212, logged by the identified colleagues 218. Determination of levels of communication between the identified colleagues 218 and the respective employees 212 is further dependent on at least number of voice communication events, with the respective employees 212, logged by the identified colleagues 218 and duration of the voice communication events.

In another implementation, the evaluation includes calculating proximity metrics dependent on commentary provided by the identified colleagues 218 about the respective employees 212. The commentary provided by the identified colleagues 218 about the respective employees 212 specifies how the identified colleagues 218 know the respective employees 212. The commentary provided by the identified colleagues 218 about the respective employees 212 includes lengths of time the identified colleagues 218 have known the respective employees 212. The commentary provided by the identified colleagues about the respective employees 212 also includes a specification of strength of their relationships with the respective employees 212. The commentary provided by the identified colleagues 218 about the respective employees 212 also assigns one or more labels to types of their relationships with the respective employees 212.

At action 1050, in response to receiving a selection of one or more identified colleagues 218 from the sales representative, an introduction request 615 is sent to the identified colleagues 218 for establishing the initial contact with the particular entity or strengthen contacts through the respective employees 212. In one implementation, the introduction request 615 can be in the form of an email, a post, or a text message. In another implementation, the introduction request 615 can include social profiles, social personas, digital business cards, images, contact information, or social handles of the sales representative.

### Computer System

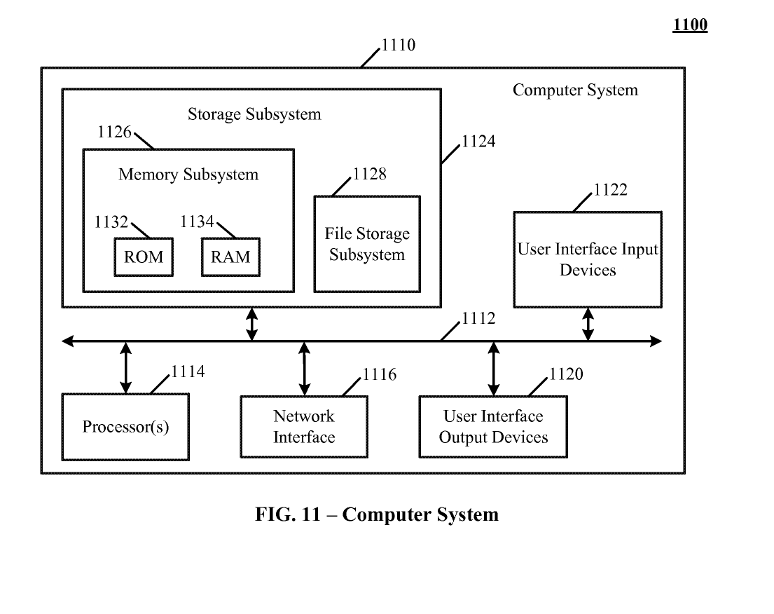

FIG. 11 is a block diagram of an example computer system 1100 for initiating contact with a prospect. Computer system 1110 typically includes at least one processor 1114 that communicates with a number of peripheral devices via bus subsystem 1112. These peripheral devices can include a storage subsystem 1124 including, for example, memory devices and a file storage subsystem, user interface input devices 1122, user interface output devices 1120, and a network interface subsystem 1116. The input and output devices allow user interaction with computer system 1110. Network interface subsystem 1116 provides an interface to outside networks, including an interface to corresponding interface devices in other computer systems.

User interface input devices 1122 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1110.

User interface output devices 1120 can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1110 to the user or to another machine or computer system.

Storage subsystem 1124 stores programming and data constructs that provide the functionality of some or all of the modules and methods described herein. These software modules are generally executed by processor 1114 alone or in combination with other processors.

Memory 1126 used in the storage subsystem can include a number of memories including a main random access memory (RAM) 1130 for storage of instructions and data during program execution and a read only memory (ROM) 1132 in which fixed instructions are stored. A file storage subsystem 1128 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 11211 in the storage subsystem 1124, or in other machines accessible by the processor.

Bus subsystem 1112 provides a mechanism for letting the various components and subsystems of computer system 1110 communicate with each other as intended. Although bus subsystem 1112 is shown schematically as a single bus, alternative implementations of the bus subsystem can use multiple busses.

Computer system 1110 can be of varying types including a workstation, server, computing cluster, blade server, server farm, or any other data processing system or computing device. Due to the ever-changing nature of computers and networks, the description of computer system 1110 depicted in FIG. 11 is intended only as one example. Many other configurations of computer system 1110 are possible having more or fewer components than the computer system depicted in FIG. 11.

### Particular Implementations

In one implementation, a method is described from the perspective of a server receiving messages from user software. The method includes receiving a selection of a particular entity from a sales representative who wants to establish an initial contact with the particular entity or strengthen contacts. It includes accessing an entity database and presenting a list of employees of the particular entity. The list identifies respective titles and job functions of the employees. It further includes accessing a social network database and identifying colleagues of the sales representative that are connected to respective employees listed in the list of employees. It also includes evaluating strength of relationships between the identified colleagues and the respective employees by determining levels of communication between the identified colleagues and the respective employees on one or more communication media and calculating proximity metrics dependent on commentary provided by the identified colleagues about the respective employees. It further includes, in response to receiving a selection of one or more identified colleagues from the sales representative, sending an introduction request to the one or more identified colleagues for establishing the initial contact with the particular entity through one or more respective employees or strengthen contacts.

This method described can be presented from the perspective of a mobile device and user software interacting with a server. From the mobile device perspective, the method includes receiving a selection of a particular entity from a sales representative, across a user interface of the mobile device, who wants to establish an initial contact with the particular entity or strengthen contacts. It includes accessing an entity database and presenting a list of employees of the particular entity across the user interface of the mobile device. The list identifies respective titles and job functions of the employees. It further includes accessing a social network database and identifying colleagues of the sales representative that are connected to respective employees listed in the list of employees. The method depends on the server for evaluating strength of relationships between the identified colleagues and the respective employees by determining levels of communication between the identified colleagues and the respective employees on one or more communication media and calculating proximity metrics dependent on commentary provided by the identified colleagues about the respective employees. It further includes, in response to receiving a selection of the identified colleagues from the sales representative, sending an introduction request to the one or more identified colleagues for establishing the initial contact with the particular entity through the respective employees or strengthen contacts.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations such as relationship strength determination environment, proximity report, commentary interface, or statistics dashboard.

Determination of levels of communication between the identified colleagues and the respective employees is dependent on number of emails exchanged between the colleagues and the respective employees on email clients. Determination of levels of communication between the identified colleagues and the respective employees is also dependent on number of chat messages exchanged between the colleagues and the respective employees on chat facilities. Determination of levels of communication between the identified colleagues and the respective employees is also dependent on number of check-in events, linked to the respective employees, logged by the identified colleagues. Determination of levels of communication between the identified colleagues and the respective employees is further dependent on at least number of voice communication events, with the respective employees, logged by the identified colleagues and duration of the voice communication events.

The commentary provided by the identified colleagues about the respective employees specifies how the identified colleagues know the respective employees. The commentary provided by the identified colleagues about the respective employees includes lengths of time the identified colleagues have known the respective employees. The commentary provided by the identified colleagues about the respective employees also includes a specification of strength of their relationships with the respective employees. The commentary provided by the identified colleagues about the respective employees also assigns one or more labels to types of their relationships with the respective employees. The method further includes presenting a ranked colleagues list that ranks the identified colleagues dependent on strength of their relationships with the respective employees of the particular entity.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

While the present technology is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the technology and the scope of the following claims.

1. A method, including:
receiving a selection of a particular entity by a sales representative who wants to establish or strengthen contact with the particular entity;
accessing an entity database and presenting a list of employees of the particular entity, wherein the list identifies respective titles and job functions of the employees;
accessing a social network database and identifying colleagues of the sales representative that are connected to respective employees listed in the list of employees;
evaluating strength of relationships between the identified colleagues and the respective employees, wherein the evaluation includes
determining levels of communication between the identified colleagues and the respective employees on one or more communication media; and
calculating proximity metrics dependent on commentary provided by the identified colleagues about the respective employees; and
in response to receiving a selection of one or more identified colleagues of the sales representative, sending an introduction request to the identified colleagues for establishing or strengthening the contact with the particular entity through the respective employees.

2. The method of claim 1, wherein determining the levels of communication between the identified colleagues and the respective employees is dependent on number of emails exchanged between the colleagues and the respective employees on email clients.

3. The method of claim 1, wherein determining the levels of communication between the identified colleagues and the respective employees is dependent on number of chat messages exchanged between the colleagues and the respective employees on chat facilities.

4. The method of claim 1, wherein determining the levels of communication between the identified colleagues and the respective employees is dependent on number of check-in events, linked to the respective employees, logged by the identified colleagues.

5. The method of claim 1, wherein determining the levels of communication between the identified colleagues and the respective employees is dependent on at least:
number of voice communication events, with the respective employees, logged by the identified colleagues; and
duration of the voice communication events.

6. The method of claim 1, wherein the commentary provided by the identified colleagues about the respective employees specifies how the identified colleagues know the respective employees.

7. The method of claim 1, wherein the commentary provided by the identified colleagues about the respective employees includes lengths of time the identified colleagues have known the respective employees.

8. The method of claim 1, wherein the commentary provided by the identified colleagues about the respective employees includes a specification of strength of their relationships with the respective employees.

9. The method of claim 1, wherein the commentary provided by the identified colleagues about the respective employees assigns one or more labels to types of their relationships with the respective employees.

10. The method of claim 1, further including presenting a ranked colleagues list that ranks the identified colleagues dependent on strength of their relationships with the respective employees of the particular entity.

11. A system, including:
a processor and a computer readable storage medium storing computer instructions configured to cause the processor to:
receive a selection of a particular entity by a sales representative who wants to establish or strengthen contact with the particular entity;
access an entity database and present a list of employees of the particular entity, wherein the list identifies respective titles and job functions of the employees;
access a social network database and identify colleagues of the sales representative that are connected to respective employees listed in the list of employees;
evaluate strength of relationships between the identified colleagues and the respective employees, wherein the evaluation includes
determining levels of communication between the identified colleagues and the respective employees on one or more communication media; and
calculating proximity metrics dependent on commentary provided by the identified colleagues about the respective employees; and
in response to receiving a selection of one or more identified colleagues from the sales representative, send an introduction request to the identified colleagues for establishing or strengthening the contact with the particular entity through the respective employees.

12. The system of claim 11, wherein determining the levels of communication between the identified colleagues and the respective employees is dependent on number of emails exchanged between the colleagues and the respective employees on email clients.

13. The system of claim 11, wherein determining the levels of communication between the identified colleagues and the respective employees is dependent on number of chat messages exchanged between the colleagues and the respective employees on chat facilities.

14. The system of claim 11, wherein determining the levels of communication between the identified colleagues and the respective employees is dependent on number of check-in events, linked to the respective employees, logged by the identified colleagues.

15. The system of claim 11, wherein determining the levels of communication between the identified colleagues and the respective employees is dependent on at least:
number of voice communication events, with the respective employees, logged by the identified colleagues; and
duration of the voice communication events.

16. The system of claim 11, wherein the commentary provided by the identified colleagues about the respective employees specifies how the identified colleagues know the respective employees.

17. The system of claim 11, wherein the commentary provided by the identified colleagues about the respective employees includes lengths of time the identified colleagues have known the respective employees.

18. The system of claim 11, wherein the commentary provided by the identified colleagues about the respective employees includes a specification of strength of their relationships with the respective employees.

19. The system of claim 11, wherein the commentary provided by the identified colleagues about the respective employees assigns one or more labels to types of their relationships with the respective employees.

20. The system of claim 11, further configured to present a ranked colleagues list that ranks the identified colleagues dependent on strength of their relationships with the respective employees of the particular entity.
